(19) United States
(12) Patent Application Publication
(10) Pub. No.: US 2026/0048830 A1
(43) Pub. Date: Feb. 19, 2026

(54) DOOR LATCHING APPARATUS

(71) Applicant: The Boeing Company, Arlington, VA (US)

(72) Inventor: Andrew James Hubbard, Saint Charles, MO (US)

(21) Appl. No.: 18/806,314

(22) Filed: Aug. 15, 2024

(51) Int. Cl. B64C 1/14; E05B 79/22

(52) U.S. Cl. CPC B64C 1/1407; E05B 79/22

(57) ABSTRACT

Door latching systems, apparatus, articles of manufacture, and methods are disclosed. An example door latch includes a lever operatively coupled to a gear, the lever to rotate based on rotation of the gear, a worm screw operatively coupled to the gear, and a cam surface opposite the lever and fixed relative to the lever. The lever contacts the cam surface between a first rotational position and a second rotational position, the second rotational position different from the first rotational position.

### FIELD OF THE DISCLOSURE

This disclosure relates generally to latches and, more particularly, to door latching apparatus.

### BACKGROUND

Door latches selectively secure doors so that the doors remain closed when not in use. The latches are activated or otherwise actuated to allow the doors to open. Many latches include a handle or a lever to receive an input to actuate the latches. Latches secure doors in a closed position and resist any external forces that may act on the doors. Aircraft from small civil aircraft to the largest commercial aircraft use many styles and designs of latches to secure doors or other hatches. Many latches for aircraft include handles or other actuation methods that fold to be flush with the aircraft mold line when closed. Door latches for outward facing aircraft doors help maintain a door seal and resist all working loads the door experiences during takeoff, flight, and landing.

### SUMMARY

An example door latch includes a lever operatively coupled to a gear, the lever to rotate based on rotation of the gear, a worm screw operatively coupled to the gear, and a cam surface opposite the lever and fixed relative to the lever. The lever contacts the cam surface between a first rotational position and a second rotational position, the second rotational position different from the first rotational position.

An example compartment of an aircraft includes a chamber disposed inside the aircraft, an opening to connect the chamber to an exterior of the aircraft, the opening disposed on a skin of the aircraft, a hatch moveably coupled to the compartment and disposed in the opening, the hatch to move between a closed position and an open position, a crank to selectively couple with a cam surface, the crank and the cam surface disposed in the chamber, the crank and the cam surface to prevent movement of the hatch towards the open position when the crank is coupled with the cam surface, and a worm drive coupled to the crank and disposed in the chamber, the worm drive to rotate the crank based on receiving an input torque.

An example aircraft includes a door covering an inner cavity of the aircraft, the door rotationally coupled to the aircraft about a first axis of rotation, the door to rotate between an open position and a closed position, the door contoured such that the door maintains an aerodynamic shape of the aircraft while in the closed position, the door including a seal around a perimeter of the door, the seal to deform when the door is in the closed position, a latch coupled to the inner cavity, the latch to selectively prevent rotation of the door, the latch including a lever having a second axis of rotation different than the first axis of rotation, a worm gear including a gear and a screw, the gear operatively coupled to the lever, and a cam to contact the lever to prevent the door from moving towards the open position when the cam contacts the lever, and a hole in a skin of the aircraft, the hole disposed proximate the screw to allow a tool to enter the hole and engage the screw.

### BRIEF DESCRIPTION OF THE DRAWINGS

FIG. 1 is an example aircraft on which an example latch can secure an example door.

FIGS. 2A and 2B illustrate the example latch securing the door of FIG. 1.

FIGS. 3A and 3B are front and side cross-sections of an example worm gear of FIG. 2B.

FIGS. 4A-4D illustrate an example lever and an example cam surface of FIG. 2B as the example lever rotates to close the example door.

FIG. 5 illustrates the example cam surface and the example lever of FIG. 2B when the example lever is in an example over-center position.

In general, the same reference numbers will be used throughout the drawing(s) and accompanying written description to refer to the same or like parts. The figures are not necessarily to scale.

### DESCRIPTION

Door latches are used to prevent doors from leaving a closed state. Known door latches for external aircraft doors are designed to balance strength requirements, aerodynamic requirements, and ease of actuation. Many known door latches fold flush with the outer surface of the aircraft, but still leave discontinuities such as holes, gaps, or lines. Some known door latches include tool interfaces or circular push-buttons. While these latches are acceptable in their use cases, more modern military aircraft may not be able to tolerate the surface discontinuities that such latches introduce.

Some known doors are highly pre-loaded towards opening, and considerable force must be applied to move the door to the closed position. Known latches often have smaller securing load capability that cannot support pre-loading. Some known latches include four-bar linkages that go on-center for holding against moderate loads but struggle with driving the door to a fully closed position. Additionally, such known latches can require larger torques and a correspondingly larger interface tools. Thus, known latches with sufficient strength to close high pre-load doors include larger aerodynamic surface discontinuities.

Door latching apparatus and methods disclosed herein use a small hole on mold line as a tool access point. A tool drives a worm gear to turn a system of levers to pull against cams to close and cinch a door shut. The worm gear allows the levers to be manually actuated to secure and release the door. The worm gear acts as a gear-reducer and 90°gearbox to reduce required input torques, thus allowing for a smaller interface tool and a correspondingly smaller discontinuity on the aerodynamic surface. The worm gear additionally resists back-driving loads during use.

Door latching apparatus and methods disclosed herein include a lever and a cam surface. The lever and the cam surface allow the latch to provide a securing load over a range of travel. Additionally, the cam surface provides an over-center benefit to generate a contact force that urges the lever towards the fully closed position. Similar to a cam latch, the lever generates greater clamping forces as it rotates against the cam surface until it reaches a stable over-center position. The cam surface can be shaped to tune desired closure mechanics that define door motion and mechanical advantage.

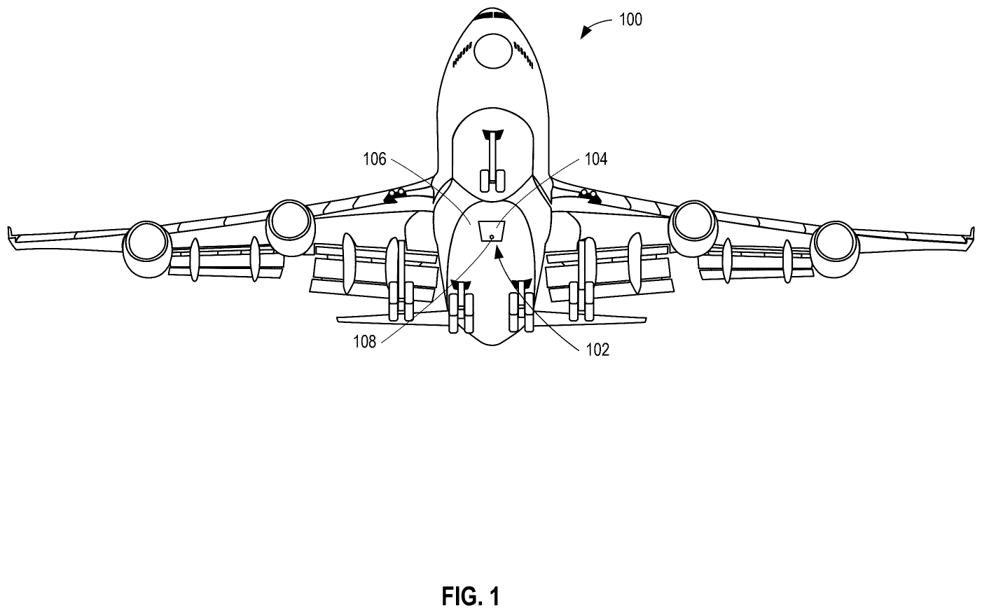

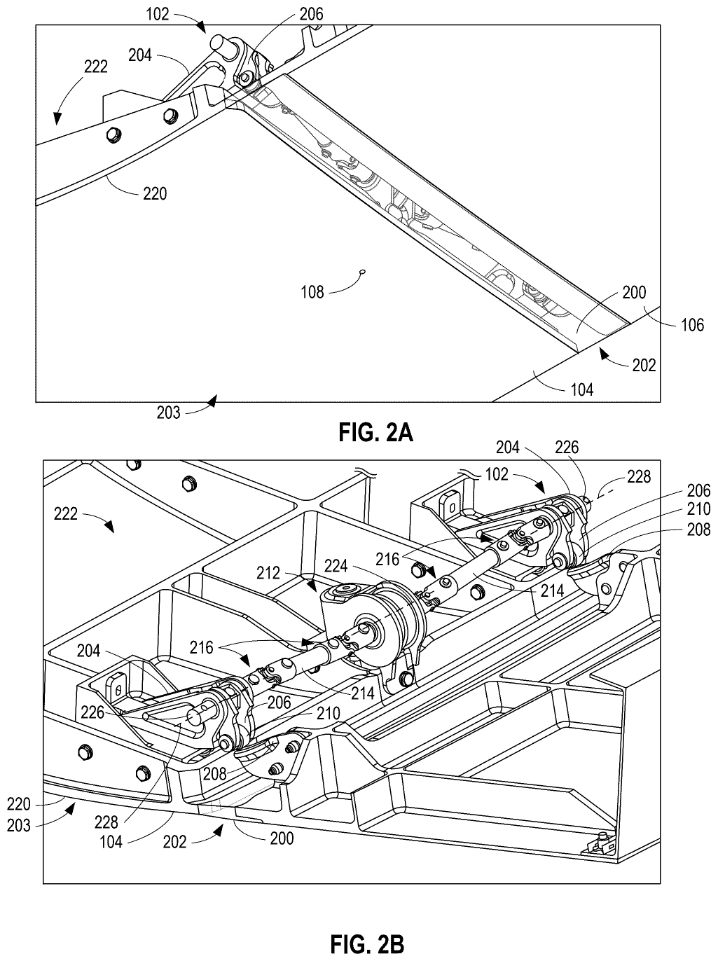

FIG. 1 is an example aircraft 100 on which an example latch 102 can secure an example door 104. The door 104 is an access door (e.g., a hatch) moveably coupled to the aircraft 100 between an open position and a closed position. In some examples, the door 104 is coupled to the aircraft 100 with a hinge. The door 104 opens to access a compartment inside of the aircraft 100 (e.g., an interior space, a chamber, an inner cavity, etc.). The outer surface of the door 104 is shaped (e.g., contoured) to follow a mold line (e.g., aerodynamic shape) of the aircraft 100 when in the closed position. In some examples, the door 104 has a planar exterior surface. In other examples, the door 104 can have a curved or irregular exterior surface. The door 104 is shown positioned on a lower portion of a fuselage 106 of the aircraft 100. However, in other examples, the door 104 can be located on a different part of the aircraft 100 (e.g., a wing, a pylon, etc.). The latch 102 is accessed by an example a circular opening 108 on the door 104 (further detailed below in relation to FIG. 2B). The opening 108 (e.g., tool interface, tool hole, etc.) allows a tool to enter the door 104 and open the latch 102. In some examples, the opening 108 is located on the aircraft 100 near an edge of the door 104.

FIGS. 2A and 2B illustrate the example latch 102 securing the door 104 of FIG. 1. For clarity, portions of the door 104 and the fuselage 106 have been removed. FIG. 2A shows the door 104 in the closed position. An example seal 200 is shown transparent to illustrate an example gap 202 between the door 104 and the fuselage 106. The seal 200 is coupled to an external side 203 of the door 104 and extends from the door 104 to overlap the fuselage 106. In this way, the seal 200 covers the gap 202 when the door 104 is in the closed position. The seal 200 deforms to seal the gap 202 when the door 104 is in the closed position. For clarity, only a portion of the seal 200 is shown.

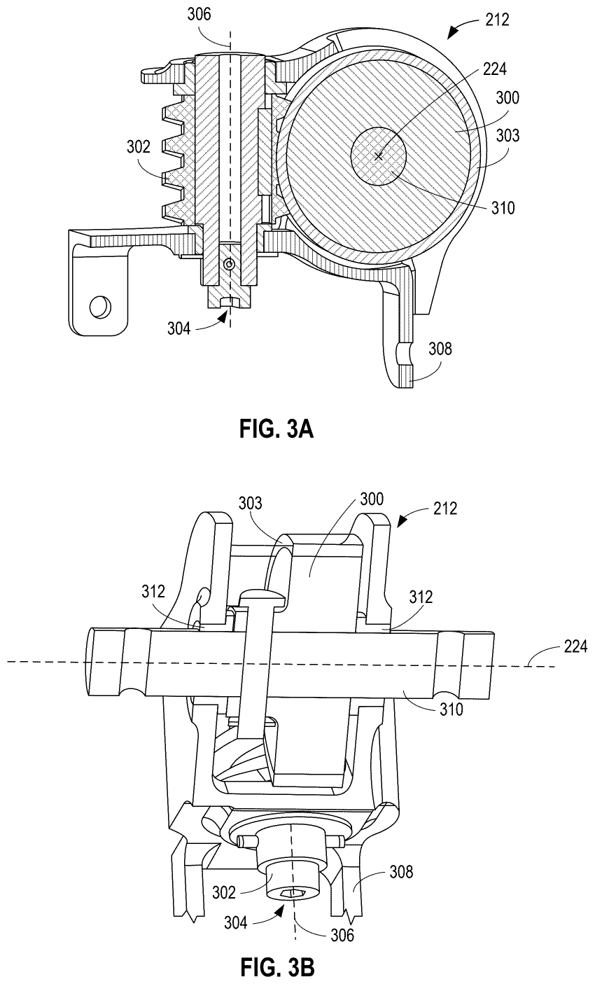

The latch 102 of FIG. 2B includes example brackets 204 rotationally coupled to corresponding example levers 206 to support the levers 206. The levers 206 (e.g., cranks) contact example cam surfaces 208 to close and secure the door 104. In other words, the levers 206 selectively couple to the cam surfaces 208 to prevent the door 104 from moving towards the open position. In some examples, the brackets 204 can be adjusted (e.g., shimmed, moved, etc.) to change an alignment of the levers 206 and the cam surfaces 208 or to change a final position of the door 104 (e.g., a total amount of deformation of the seal 200) when the door 104 is in the closed position. In some examples, the levers 206 include example rollers 210 to reduce friction between the levers 206 and the cam surfaces 208. The latch 102 is actuated by an example worm gear 212 (e.g., a worm drive), described in more detail below in reference to FIGS. 3A and 3B. The worm gear 212 is operatively coupled to the levers 206 to cause the levers 206 to rotate based on rotation of the worm gear 212. In some examples, the worm gear 212 is operatively coupled to the levers 206 via example torque tubes 214 (e.g., tubes, rods, members, etc.). In some examples, the torque tubes 214 include example universal joints 216 to compensate for any misalignment with the brackets 204 and/or the worm gear 212. The door 104 of FIG. 2A includes the example opening 108 proximate the worm gear 212 to receive a tool. The opening 108 aligns with the worm gear 212 so that the tool can enter the opening 108 from the external side 203 of the door 104 and engage the worm gear 212. In this way, the worm gear 212 and, more broadly, the latch 102 is actuated by the tool. In some examples, the tool is a manual tool (e.g., a hexagonal key, a screwdriver, a socket wrench, etc.) that can extend through the opening 108 and engage with the worm gear 212. In other examples, the tool can be an automated tool (e.g., an electric screwdriver) with an attachment to an interface with the worm gear 212.

The seal 200 surrounds the door 104 (e.g., a perimeter of the door 104) and covers the gap 202 that surrounds the door 104. In some examples, the seal 200 is shaped to slope inward (e.g., towards the fuselage 106) from an example mold line 220 of the door 104 when the door 104 is in the open position. As the door 104 moves to the closed position, the seal 200 elastically deforms (e.g., bends, flexes, compresses, etc.) to match the mold line 220. The seal 200 contacts the fuselage 106 and exerts pressure on the fuselage 106 that increases relative to a total deformation of the seal 200. The pressure generated by the deformed seal 200 seals the door 104 to the fuselage 106 to prevent fluids from moving through the gap 202. In some examples, the seal 200 deforms to mate with a mold line of the fuselage 106 and to close any gaps or discontinuities between the seal 200 and the fuselage 106. In some examples, the seal 200 includes an elastomeric material. The seal 200 of FIGS. 2A and 2B is shown as a flange. In other examples, the seal 200 can have a different shape or location relative to the door 104 and the fuselage 106. In some examples, the door 104 includes a flange and the seal 200 is compressed between the door 104 and the fuselage 106.

The latch 102 of FIGS. 2A and 2B is coupled to an internal side 222 of the door 104. In some examples, the worm gear 212 is coupled to the door 104 and coupled to the torque tubes 214 to rotate the torque tubes 214. In some examples, the torque tubes 214 couple to the worm gear 212 at an example axis of rotation 224 of the worm gear 212 and extend away from the worm gear 212. The torque tubes 214 are shown as cylinders extending from the worm gear 212. In other examples, the torque tubes 214 can have a different shape to transfer a torque required to actuate the latch 102. In some examples the torque tubes 214 are hollow tubes to reduce a weight of the torque tubes 214. The torque tubes 214 of FIG. 2B are shown with an example size (e.g., a diameter) and an example length to couple to the levers 206. In other examples, the torque tubes 214 can have a different size and a different length. The levers 206 are shown at an example distance from the worm gear 212. In other examples, the levers 206 can have a different position and/or orientation relative to the worm gear 212. In some examples, the levers 206 are evenly spaced from the worm gear 212. In other examples, the levers 206 are asymmetrically positioned relative to the worm gear 212. In some examples, example universal joints 216 couple the torque tubes 214 to the worm gear 212 and/or the levers 206 to compensate for any misalignment between the worm gear 212 and the levers 206.

The levers 206 of the latch 102 of FIG. 2B are coupled to the internal side of the 222 of the door 104 (e.g., within an inner cavity, within a chamber, within a compartment etc.). In some examples the levers 206 rotate within planes approximately orthogonal to the mold line 220 (e.g., a skin of the aircraft 100, the fuselage 106, etc.). In some examples, the levers 206 include two parallel portions to support the rollers 210. In other examples, the levers 206 can have different shapes (e.g., solid beam, flanged, etc.). The brackets 204 support the levers 206 and allow the levers 206 to rotate. In some examples, the brackets 204 are coupled to the door 104 and transfer reaction forces from the levers 206 to the door 104. In some examples, the brackets 204 include bearings (e.g., ball bearings) to support the reaction forces from the levers 206 while allowing the levers 206 to rotate freely. In some examples, the levers 206 are coupled to example shafts 226 that are rotationally coupled to the brackets 204. In some examples, the brackets 204 include two parallel portions to support the levers 206 and define example axes of rotation 228 of the levers 206. In other examples, the brackets 204 can have different shapes. The latch 102 of FIG. 2B includes two brackets 204 and two levers 206. In other examples, the latch 102 can include any number of brackets 204 and levers 206 (e.g., one bracket 204 and lever 206, three brackets 204 and levers 206, four brackets 204 and levers 206, etc.), the levers 206 coupled to the worm gear 212 via corresponding ones of the torque tubes 214. In this way, the worm gear 212 can actuate any number of levers 206 along the door 104 that contact a corresponding number of the cam surfaces 208 at approximately a same time.

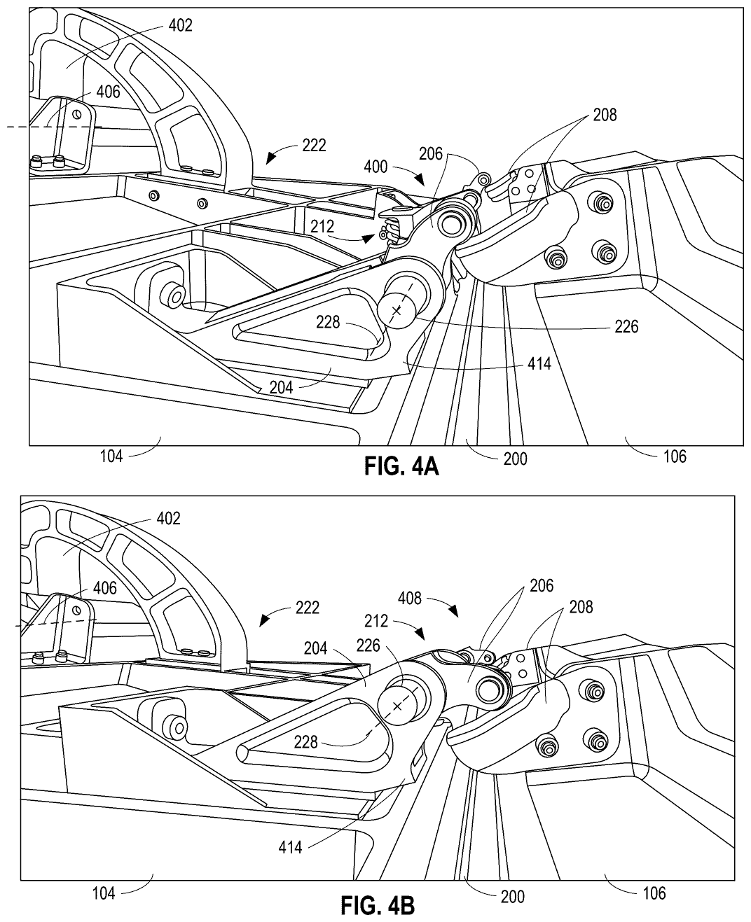

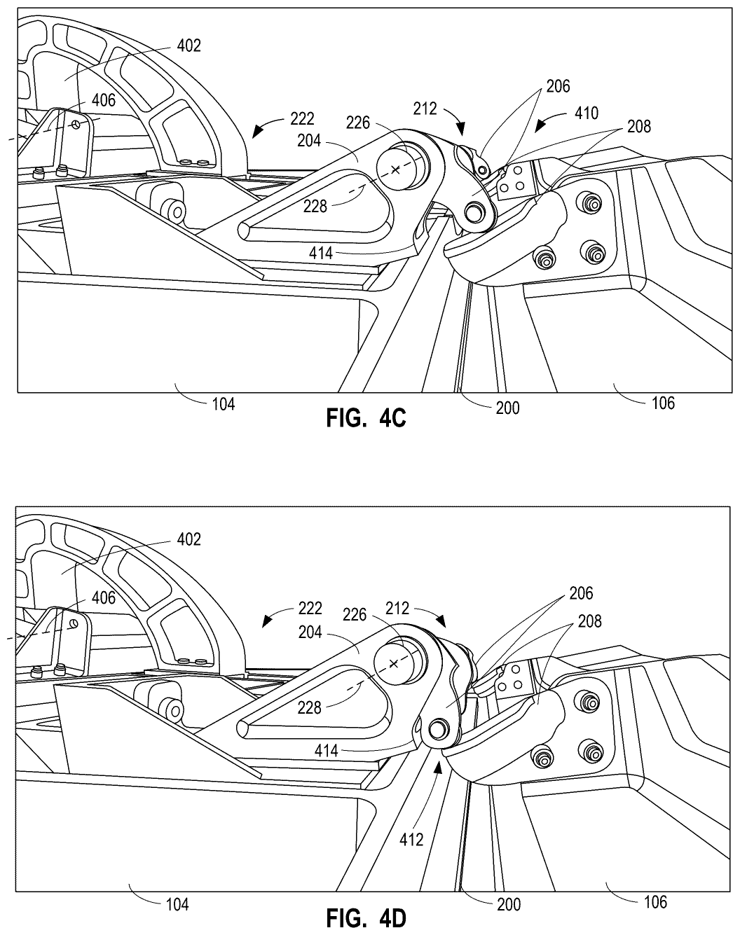

The cam surfaces 208 (e.g., cams, cam brackets, etc.) of FIG. 2B are coupled to the fuselage 106 and/or an underlying structure of the aircraft 100. As described in more detail below in relation to FIGS. 4A-4D, the cam surfaces 208 contact the levers 206 (e.g., the rollers 210 of the levers 206) as the levers 206 rotate. In this way, the levers 206 are compressed between the cam surfaces 208 and the brackets 204, causing the seal 200 to deform and the door 104 to move into a fully closed position. In some examples, the cam surfaces 208 are wider than the levers 206 (e.g., the rollers 210 of the levers 206) to accommodate for any misalignment between the levers 206 and the cam surfaces 208. In some examples, the cam surfaces 208 are coupled to the door 104 and the latch 102, including the brackets 204, the levers 206, and the worm gear 212, is coupled to the fuselage 106.

FIGS. 3A and 3B are front and side cross-sections of the example worm gear 212 of FIG. 2B. The worm gear 212 (e.g., worm drive) includes an example gear 300 (e.g., worm wheel) and an example screw 302 (e.g., worm screw). The gear 300 of FIGS. 3A and 3B is depicted without gear teeth, but it should understood that an example tooth section 303 includes gear teeth of appropriate size and pitch to mesh with the screw 302. The screw 302 receives an input torque via an example recess 304 (e.g., tool interface, hex socket, cruciform drive, etc.). The screw 302 rotates about an example axis of rotation 306 in response to the input torque. The gear 300 interfaces with the screw 302 such that rotation of the screw 302 about the axis of rotation 306 causes the gear 300 to rotate about the axis of rotation 224. An example bracket 308 couples to the gear 300 and the screw 302 to prevent the gear 300 and the screw 302 from translating relative to the bracket 308. In some examples, the bracket 308 couples to the door 104 (not shown) and supports loads received by the gear 300 and the screw 302. In some examples, the gear 300 couples to the levers 206, the torque tubes 214, and/or the universal joints 216 via an example gear shaft 310. The gear shaft 310 is rotationally coupled to the bracket 308 to allow the gear shaft 310 to rotate about the axis of rotation 224. In some examples, the gear shaft 310 is supported by example bearings 312 located on opposite sides of the gear 300. The bracket 308, the gear 300, and the screw 302 of FIGS. 3A and 3B are shown in an example orientation. In other examples, the bracket 308, the gear 300, and the screw 302 can have different orientations resulting in differently oriented axes of rotation 224, 306.

The worm gear 212 of FIGS. 3A and 3B provides a mechanical advantage in actuating the latch 102. The screw 302 rotates to apply a force to the gear 300, resulting in the gear 300 rotating. The input torque received by the screw 302 is multiplied by an example gear ratio between the gear 300 and the screw 302 to generate an output torque generated by the gear 300. In this way, the input torque required to actuate the latch 102 and fully close (e.g., seal) the door 104 can be reduced. Reducing the required input torque allows a smaller tool and, relatedly, a smaller opening 108 (not shown). In this way, the worm gear 212 allows the size of the opening 108 to be reduced and the corresponding interruption (e.g., surface discontinuity) in the aerodynamic surface of the aircraft 100 to be reduced. Additionally, the worm gear 212 reduces the likelihood of the of the latch 102 loosening (e.g., back-driving) or otherwise beginning to open as a result of vibrations or other working loads acting on the door 104 during flight of the aircraft 100.

FIGS. 4A-4D illustrate the example lever 206 and the example cam surface 208 of FIG. 2B as the lever 206 rotates to close the example door 104. The lever 206 of FIG. 4A is rotated to an example first rotational position 400 of initial contact. The first rotational position 400 represents a near closed position of the door 104, where the seal 200 is not deformed. The lever 206 prevents the door 104 from moving towards the open position when in the first rotational position 400. From the first rotational position 400, the lever 206 can rotate away from the cam surface 208 (e.g., counterclockwise) or towards the cam surface 208 (e.g., clockwise). If the lever 206 moves away from the cam surface 208 from the first rotational position 400, the lever 206 will no longer contact the cam surface 208 and the door 104 is allowed to move towards the open position. In some examples, the door 104 rotates via an example hinge 402 to move from the open position to the closed position. Once near the closed position, the door 104 is secured by rotating the lever 206 towards the cam surface 208. In some examples, the axis of rotation 228 of the lever 206 is parallel to an example axis of rotation 406 of the hinge 402. In this way, the lever 206 aligns with the cam surface 208 as the door 104 rotates about the axis of rotation 406.

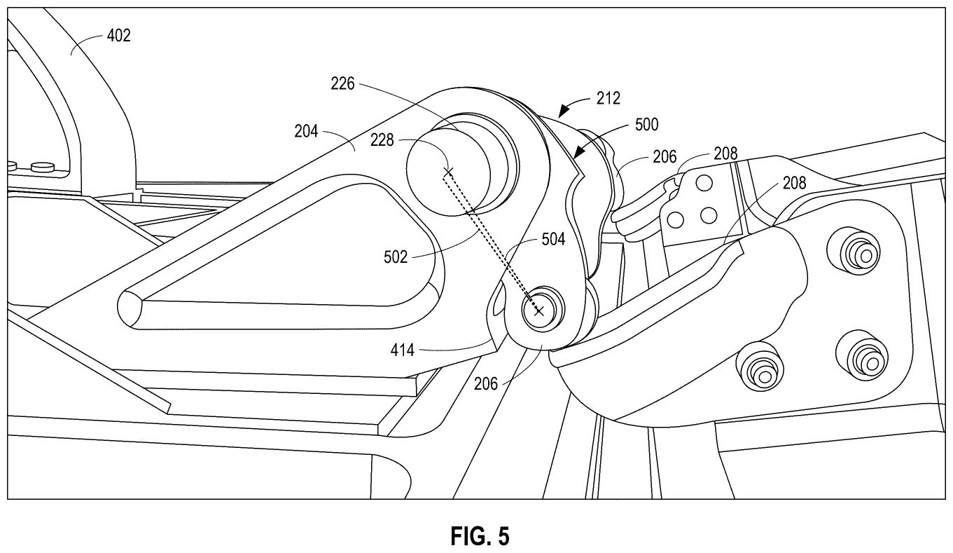

FIG. 4B shows the lever 206 in an example second rotational position 408 of increasing load. When the lever 206 rotates from the first rotational position 400 towards the second rotational position 408, the door 104 moves closer to the closed position and the seal 200 begins to deform. The loads transferred to the lever 206 are relatively small and include a torque component. FIG. 4C shows the lever 206 as it continues to rotate towards the cam surface 208 to an example third rotational position 410. In the third rotational position 410, the door 104 is near the closed position and the seal 200 is nearly fully deformed. As such, the seal 200 exerts a strong force (e.g., 400 pounds) on the fuselage 106 that biases the door 104 to move towards the open position. In the third rotational position 410, the loads transferred to the lever 206 include mainly compressive forces as the contact angle approaches on-center alignment. As discussed in further detail below in reference to FIG. 5, on-center alignment refers to the contact forces between the lever 206 and the cam surface 208 aligning with or directed toward the axis of rotation 228. FIG. 4D shows the lever 206 as it completes its rotation and ends in an example fourth rotational position 412. In some examples, the lever 206 contacts an example stop 414 of the bracket 204 when the lever 206 is in the fourth rotational position 412. The stop 414 provides feedback (e.g., a jump in resistance to the input torque) to signal that the lever 206 has completed rotating and the latch 102 is fully actuated (e.g., locked, latched, secured, etc.).

The cam surfaces 208 are shaped (e.g., include a profiled surface) to interact with the lever 206 during closing and latching the door 104. The point of contact between the lever 206 and the cam surface 208 defines a direction of the reaction force (e.g., a normal force, a contact force, etc.) between the cam surface 208 and the lever 206. The direction of the reaction force relative to the axis of rotation 228 determines how much torque and how much compression the lever 206 receives. Thus, the cam surface 208 can be designed to change the direction of the reaction force as the lever 206 rotates between rotational positions 400,408,410,412. In some examples, the cam surface 208 is profiled to provide a constant, or near constant, torque profile (e.g., the input torque provided to the worm gear 212 to move the lever 206 between the first rotational position 400 and the fourth rotational position 412). For example, the reaction force generated in the first rotational position 400 and the second rotational position 408 are directed away from the axis of rotation 228, which increases a torque acting on the lever 206. Thus, the input torque required to rotate the lever 206 when the seal 200 is generating relatively low loads is increased as a larger portion of the reaction force generates torque. The reaction forces generated in the third rotational position 410 and the fourth rotational position 412 are directed towards the axis of rotation 228 to decrease the torque acting on the lever 206. Thus, the input torque required to rotate the lever 206 when the seal 200 is generating relatively high loads (e.g., due to increased deformation of the seal 200) is reduced as a smaller portion of the reaction force generates torque. In this way, the input torque required to move the lever 206 between the first rotational position 400 and the fourth rotational position 412 is approximately the same despite the seal 200 providing increasing resistance as the door 104 approaches the closed position. In other examples, the cam surface 208 can be profiled to provide a different kinematic performance (e.g., a gradually increasing torque curve, an increased rate of closing the door 104, etc.).

FIG. 5 illustrates the example cam surfaces 208 and the example levers 206 of FIG. 2B when the example levers 206 are in an example over-center rotational position 500. The over-center rotational position 500 represents a position where an example over-center reaction force 502 is directed past (e.g., two degrees beyond) the axis of rotation 228 in a way that directs the lever 206 towards the fully actuated position (e.g., the fourth rotational position 412). In some examples, the over-center rotational position 500 directs the lever 206 to contact the example stop 414. In this way, the latch 102 is secured against unintended opening (e.g., loosening) based on external loads and/or vibrations. In other examples, the cam surface 208 is shaped to provide an example on-center reaction force 504 directed to the axis of rotation 228 when the fully actuated position (e.g., the fourth rotational position 412). The on-center reaction force 504 provides a static compression force to the lever 206 without any biasing and/or static torque. In other rotational positions of the lever 206 (e.g., rotational positions 400,408,410), the reaction force biases the lever 206 to move away from the cam surface 208.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that latch preloaded doors while utilizing small interfaces. This advantageously allows doors, such as those on aircraft, to be secured and opened with smaller discontinuities on the skin of the aircraft. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to latch doors are disclosed herein. Further examples and combinations thereof include the following:
Example 1 includes a door latch comprising a lever operatively coupled to a gear, the lever to rotate based on rotation of the gear, a worm screw operatively coupled to the gear, and a cam surface opposite the lever and fixed relative to the lever, the lever to contact the cam surface between a first rotational position and a second rotational position, the second rotational position different from the first rotational position.
Example 2 includes the door latch of example 1, wherein the lever includes a roller rotationally coupled to an end of the lever, the roller to contact the cam surface between the first rotational position and the second rotational position.
Example 3 includes the door latch of any one of examples 1-2, wherein the gear is operatively coupled to the lever via a torque tube.
Example 4 includes the door latch of example 3, wherein the torque tube includes a universal joint between a first end of the torque tube and a second end of the torque tube, the first end to rotate about a first axis and the second end to rotate about a second axis.
Example 5 includes the door latch of any one of examples 1-4, further comprising a bracket rotationally coupled to the lever.
Example 6 includes the door latch of example 5, wherein the bracket includes a stop to contact the lever when the lever is in the second rotational position, the stop to contact the lever at an end of the lever opposite an axis of rotation of the lever.
Example 7 includes the door latch of example 6, wherein the cam surface is angled relative to the lever when the lever is in the second rotational position such that a contact force of the cam surface is directed towards at least one of the axis of rotation or the stop.
Example 8 includes the door latch of any one of examples 1-7, wherein the worm screw includes an interface to receive a tool and transfer a torque from the tool to the worm screw.
Example 9 includes the door latch of any one of examples 1-8, wherein the lever is a first lever and the cam surface is a first cam surface, and the door latch further includes a second lever operatively coupled to the gear, the second lever to contact a second cam surface.
Example 10 includes the door latch of example 9, wherein the gear is disposed between the first lever and the second lever.
Example 11 includes a compartment of an aircraft comprising a chamber disposed inside the aircraft, an opening to connect the chamber to an exterior of the aircraft, the opening disposed on a skin of the aircraft, a hatch moveably coupled to the compartment and disposed in the opening, the hatch to move between a closed position and an open position, a crank to selectively couple with a cam surface, the crank and the cam surface disposed in the chamber, the crank and the cam surface to prevent movement of the hatch towards the open position when the crank is coupled with the cam surface, and a worm drive coupled to the crank and disposed in the chamber, the worm drive to rotate the crank based on receiving an input torque.
Example 12 includes the compartment of example 11, wherein the hatch includes a seal to elastically deform when the hatch moves from the open position to the closed position.
Example 13 includes the compartment of example 12, wherein the crank couples to the cam surface between a first rotational position and a second rotational position, the cam surface profiled such that the crank causes increased deformation of the seal as the crank moves between the first rotational position and the second rotational position.
Example 14 includes the compartment of example 13, wherein the hatch and the seal match a mold line of the aircraft when the hatch is in the closed position and the crank is in the second rotational position.
Example 15 includes the compartment of any one of examples 13-14, wherein the cam surface is profiled such that the input torque is approximately constant as the crank moves between the first rotational position and the second rotational position and the seal deforms.
Example 16 includes the compartment of any one of examples 11-15, wherein the hatch includes a tool hole to receive a tool from the exterior of the aircraft, the tool to generate the input torque.
Example 17 includes an aircraft comprising a door covering an inner cavity of the aircraft, the door rotationally coupled to the aircraft about a first axis of rotation, the door to rotate between an open position and a closed position, the door contoured such that the door maintains an aerodynamic shape of the aircraft while in the closed position, the door including a seal around a perimeter of the door, the seal to deform when the door is in the closed position, a latch coupled to the inner cavity, the latch to selectively prevent rotation of the door, the latch including a lever having a second axis of rotation different than the first axis of rotation, a worm gear including a gear and a screw, the gear operatively coupled to the lever, and a cam to contact the lever to prevent the door from moving towards the open position when the cam contacts the lever, and a hole in a skin of the aircraft, the hole disposed proximate the screw to allow a tool to enter the hole and engage the screw.
Example 18 includes the aircraft of example 17, wherein the cam includes a profiled surface and the lever contacts the cam while the lever is positioned between a first position and a second position.
Example 19 includes the aircraft of example 18, wherein the profiled surface is shaped such that the door moves towards the closed position when the lever moves from the first position to the second position.
Example 20 includes the aircraft of any one of examples 17-19, wherein the lever is a plurality of levers and the cam is a plurality of cams, respective ones of the plurality of levers to contact corresponding ones of the plurality of cams.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A door latch comprising:
a lever operatively coupled to a gear, the lever to rotate based on rotation of the gear;
a worm screw operatively coupled to the gear; and
a cam surface opposite the lever and fixed relative to the lever, the lever to contact the cam surface between a first rotational position and a second rotational position, the second rotational position different from the first rotational position.

2. The door latch of claim 1, wherein the lever includes a roller rotationally coupled to an end of the lever, the roller to contact the cam surface between the first rotational position and the second rotational position.

3. The door latch of claim 1, wherein the gear is operatively coupled to the lever via a torque tube.

4. The door latch of claim 3, wherein the torque tube includes a universal joint between a first end of the torque tube and a second end of the torque tube, the first end to rotate about a first axis and the second end to rotate about a second axis.

5. The door latch of claim 1, further comprising a bracket rotationally coupled to the lever.

6. The door latch of claim 5, wherein the bracket includes a stop to contact the lever when the lever is in the second rotational position, the stop to contact the lever at an end of the lever opposite an axis of rotation of the lever.

7. The door latch of claim 6, wherein the cam surface is angled relative to the lever when the lever is in the second rotational position such that a contact force of the cam surface is directed towards at least one of the axis of rotation or the stop.

8. The door latch of claim 1, wherein the worm screw includes an interface to receive a tool and transfer a torque from the tool to the worm screw.

9. The door latch of claim 1, wherein the lever is a first lever and the cam surface is a first cam surface, and the door latch further includes a second lever operatively coupled to the gear, the second lever to contact a second cam surface.

10. The door latch of claim 9, wherein the gear is disposed between the first lever and the second lever.

11. A compartment of an aircraft comprising:
a chamber disposed inside the aircraft;
an opening to connect the chamber to an exterior of the aircraft, the opening disposed on a skin of the aircraft;
a hatch moveably coupled to the compartment and disposed in the opening, the hatch to move between a closed position and an open position;
a crank to selectively couple with a cam surface, the crank and the cam surface disposed in the chamber, the crank and the cam surface to prevent movement of the hatch towards the open position when the crank is coupled with the cam surface; and
a worm drive coupled to the crank and disposed in the chamber, the worm drive to rotate the crank based on receiving an input torque.

12. The compartment of claim 11, wherein the hatch includes a seal to elastically deform when the hatch moves from the open position to the closed position.

13. The compartment of claim 12, wherein the crank couples to the cam surface between a first rotational position and a second rotational position, the cam surface profiled such that the crank causes increased deformation of the seal as the crank moves between the first rotational position and the second rotational position.

14. The compartment of claim 13, wherein the hatch and the seal match a mold line of the aircraft when the hatch is in the closed position and the crank is in the second rotational position.

15. The compartment of claim 13, wherein the cam surface is profiled such that the input torque is approximately constant as the crank moves between the first rotational position and the second rotational position and the seal deforms.

16. The compartment of claim 11, wherein the hatch includes a tool hole to receive a tool from the exterior of the aircraft, the tool to generate the input torque.

17. An aircraft comprising:
a door covering an inner cavity of the aircraft, the door rotationally coupled to the aircraft about a first axis of rotation, the door to rotate between an open position and a closed position, the door contoured such that the door maintains an aerodynamic shape of the aircraft while in the closed position, the door including a seal around a perimeter of the door, the seal to deform when the door is in the closed position;
a latch coupled to the inner cavity, the latch to selectively prevent rotation of the door, the latch including:
a lever having a second axis of rotation different than the first axis of rotation;
a worm gear including a gear and a screw, the gear operatively coupled to the lever; and
a cam to contact the lever to prevent the door from moving towards the open position when the cam contacts the lever; and
a hole in a skin of the aircraft, the hole disposed proximate the screw to allow a tool to enter the hole and engage the screw.

18. The aircraft of claim 17, wherein the cam includes a profiled surface and the lever contacts the cam while the lever is positioned between a first position and a second position.

19. The aircraft of claim 18, wherein the profiled surface is shaped such that the door moves towards the closed position when the lever moves from the first position to the second position.

20. The aircraft of claim 17, wherein the lever is a plurality of levers and the cam is a plurality of cams, respective ones of the plurality of levers to contact corresponding ones of the plurality of cams.
